(19) United States
(12) Patent Application Publication
(10) Pub. No.: US 2022/0288515 A1
(43) Pub. Date: Sep. 15, 2022

(54) SYSTEM AND METHOD FOR CONTAINING AND TRANSPORTING MATERIALS EMITTING SMELLS AND ODORS

(71) Applicant: Philip Junn-Heem Li, Toronto (CA)

(72) Inventor: Philip Junn-Heem Li, Toronto (CA)

(73) Assignee: Kulbi Goods Inc, Toronto, ON (CA)

(21) Appl. No.: 17/197,874

(22) Filed: Mar. 10, 2021

(51) Int. Cl. B01D 39/08; B32B 5/02

(52) U.S. Cl. CPC B01D 39/08; B32B 5/022; B01D 2239/0618; B01D 2239/065; B01D 2253/102; B32B 2439/40

(57) ABSTRACT

A smell-proof portable container is provided comprising a portable case and a compartment within the case. The compartment contains a lining comprising an inner layer comprising a non-woven fabric, a middle layer comprising active carbon filtering material, and an outer layer comprising the non-woven fabric. The middle layer adsorbs odor particles and pollutant particles emitted by contents of the compartment. The active carbon filtering material comprises carbon filter fiber with activated carbon. The lining is directed to preventing smells and odors associated with the contents from being externally detectable.

### FIELD OF THE INVENTION

The present disclosure is in the field of odor containment and control. More particularly, the present disclosure describes a multi-layer system for containing and filtering dirt, dust, and debris and thereafter odors and pollutants from various materials.

### BACKGROUND

Many organic and inorganic materials emit smells and odors that are detectable, noticeable, potentially offensive, and which may therefore attract attention. Persons seeking to store and transport some materials may wish that smells and odors emitted by the materials are not detectable.

Researchers, scientists, law enforcement professionals may need to transport chemicals, specimens of human or animal feces, animal and fish products, and human products such as decaying, gangrenous, or burnt flesh. More pleasant-smelling materials such as perfumes, spices, and other consumable materials may need to be transported wherein the person handling the item desires privacy.

### BRIEF DESCRIPTION OF THE DRAWINGS

FIG. 1 is a diagram of a system for containing and transporting materials emitting smells and odors according to an embodiment of the present disclosure.

FIG. 2 is a diagram of a system for containing and transporting materials emitting smells and odors according to an embodiment of the present disclosure.

FIG. 3 is a diagram of a system for containing and transporting materials emitting smells and odors according to an embodiment of the present disclosure.

### DETAILED DESCRIPTION

Systems and methods described herein are directed to preventing odors emitted by a material held in a container from being externally detectable. The container, which may be a portable case, has at least one compartment with a lining made of about three layers comprising different materials.

A first layer is a non-woven fabric that may be made of polyester. The second layer is a carbon filter layer. The third and outermost layer is made of the same materials as the first layer. The carbon filter layer is hence cushioned or sandwiched on both sides by the non-woven fabric layers.

The portable case may have an outer shell made of a durable material, features a heavy-duty lock, and is shock-proof and waterproof. The case may be referred to commercially as The Blackbox Smell Proof Stash Box.

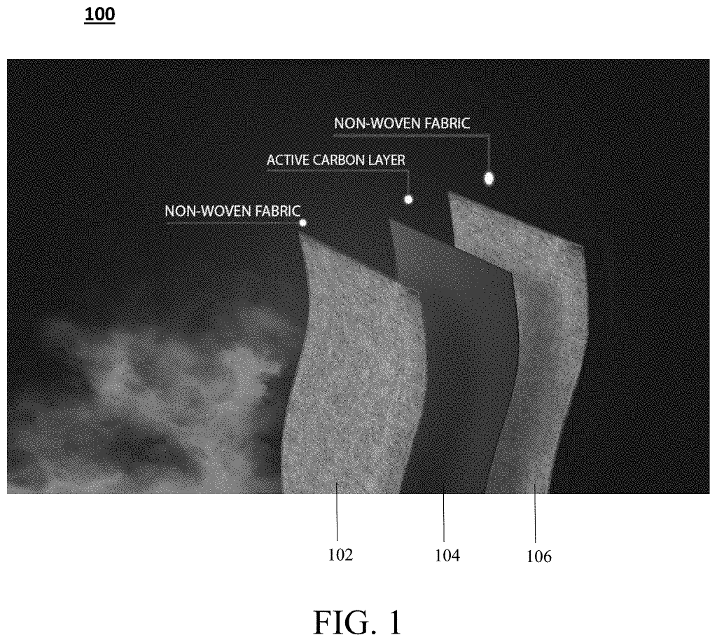

Turning to the figures, FIG. 1 depicts components and interactions of a portable smell-proof container with a multiple-layer lining. FIG. 1 depicts components of a system 100 comprising a first layer 102, a second layer 104, and a third layer 106.

The term “lining” as used herein includes the first through the third layers 102-106 together. The term also includes any subcomponents or other materials in addition to the layers 102-106 that may adhere the layers 102-106 together and otherwise assist in containing odors emitted by the contained material.

The lining may comprise the layers 102-106 covering all six surfaces (four sides, top, and bottom) of a compartment of the case. The lining may alternatively comprise the layers 102-106 covering fewer than all six surfaces.

The first layer 102 and the third layer 106 are the non-woven fabric layers that are held together by small fibers directed to maintaining structural integrity of fibers of the second layer 104. The first layer 102 stops dirt, dust, and debris emitted by the material such that only non-solid materials, i.e. gaseous smells and odors, are allowed to reach the second layer 104.

The second layer 104 is the carbon filter layer that adsorbs odors and pollutants remaining after the first layer 102 has completed its filtering. The second layer 104 comprises active carbon filtering material comprising carbon filter fiber with activated carbon.

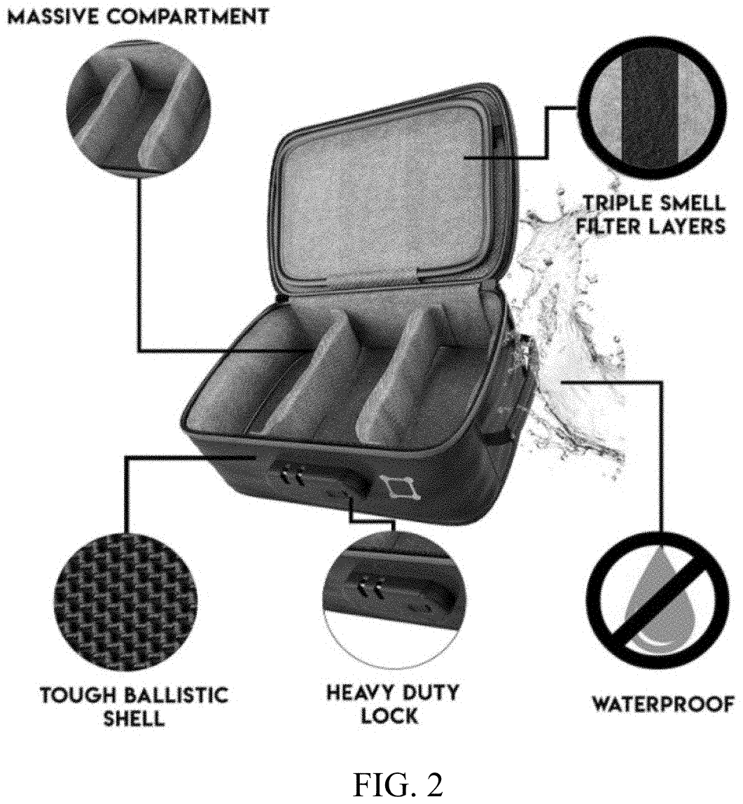

FIG. 2 illustrates a sample case and its components in accordance with an embodiment of the present disclosure with certain features labeled. In the example of FIG. 2, the case has three rectangular compartments. In embodiments, more than or less than three compartments may be provided. The designation “triple smell filter layers” in FIG. 2 indicates the layers 102-106 provided by the system 100. While the outer surface of the sample case shown in FIG. 2 is described as “tough ballistic shell,” in embodiments the outer surface may be made of any of a plurality of materials.

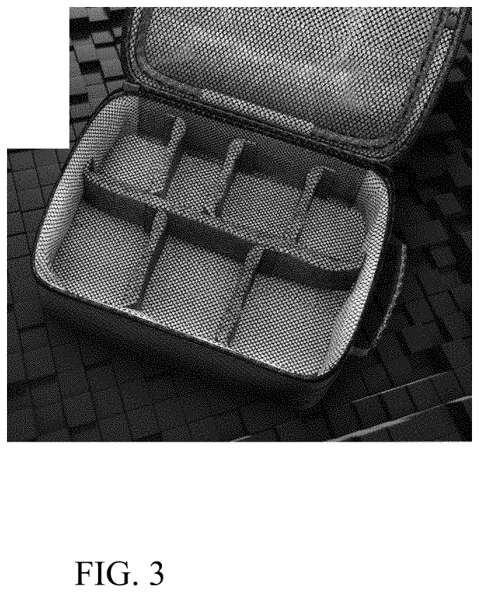

FIG. 3 illustrates another sample case which includes insert panels allowing a number of compartments to be created. In embodiments and as noted, all four sides as well as top and bottom of each compartment would be lined as described herein.

As noted, examples of items that may be held in the case or container may comprise those that emit unpleasant odors such as chemicals or animal and human products. Other materials may comprise foods, perfumes, personal care products, and non-food consumables such as tobacco products and cannabis-related materials. Some materials may emit odors that are not unpleasant but wherein the party transporting or otherwise in possession of the materials wishes the odors to remain not easily detectable.

In an embodiment, lining or other materials made of the layers 102-106 may not be used in a case, container, or other portable object. They may instead be used in other odor-limiting applications not directly involving a container for storage and/or transportation purposes.

The carbon filter layer relies at least on the principle of adsorption in containing smells and odors of contained materials. The second layer 104 comprises active carbon filtering material comprises carbon filter fiber strands with activated carbon in fabric form. The first layer and the second layer of non-woven fabric may be made of a synthetic polyester.

Systems and methods provided herein may be used for cases, storage, and luggage applications such as those depicted in FIG. 2 and FIG. 3. While those items of storage and portable containers so depicted may be segregated into compartments by dividers as is depicted, in embodiments no dividers may be used. Individual compartments may be fully lined (four sides, top, and bottom) with linings as described herein.

In an embodiment, a smell-proof portable container is provided comprising a portable case and a compartment within the case, the compartment containing a lining comprising an inner layer comprising a non-woven fabric, a middle layer comprising active carbon filtering material, and an outer layer comprising the non-woven fabric, wherein the middle layer adsorbs odor particles and pollutant particles emitted by contents of the compartment. The active carbon filtering material comprises carbon filter fiber with activated carbon. The lining is directed to preventing smells and odors associated with the contents from being externally detectable. The contents comprise at least one of human products, animal products, food, spices, smokable materials, and chemical materials. The inner and outer layer are made of at least one of a breathable synthetic component and a breathable natural component. The non-woven fabric is held together by small fibers directed to supporting structural integrity of an inner-facing surface of fibers of the middle layer. The inner layer prevents at least one of dirt, dust, and debris from passing to the middle layer. The case comprises multiple compartments containing the lining.

In another embodiment, a method of containing odors emitted by contained materials is provided. The method comprises a portable container receiving storage of an odiferous material, the material emitting at least one of gaseous and solid effluent. The method also comprises the container, via a first layer, collecting at least one of dirt, dust, and debris emitted by the material. The method also comprises the container, via a second layer, collecting odor particles and pollutant particles from the material. The method also comprises the container, via a third and outermost layer, further collecting effluent associated with the material. The method also comprises the first, second, and third layers together comprising a lining of a compartment of the container. The method also comprises the lining and a casing of the container promoting prevention of external detection of odors emitted by the material. The second layer comprises active carbon filtering material comprising carbon filter fiber with activated carbon. The first and third layer are made of at least one of a breathable synthetic component and a breathable natural component. The container has a plurality of compartments containing the lining.

In yet another embodiment, a system for containing odors and particles emitted by materials is provided comprising a portable container and a compartment within the container, the compartment containing odiferous materials and lined with a first layer of non-woven fabric, a carbon filter layer held in place by the first layer, and a second layer of non-woven fabric. The first layer promotes prevention at least one of dirt, dust, and debris associated with the materials from passing to the carbon filter layer. The carbon filter layer adsorbs odor particles and pollutant particles emitted by the materials. The carbon filter layer is made from active carbon filtering material, the filtering material comprising carbon filter fiber with activated carbon. The first layer and the second layer of non-woven fabric are made of at least one of a breathable synthetic component and a breathable natural component. The first layer is held together by small fibers directed to maintaining structural integrity of an inner-facing surface of fibers of the carbon filter layer.

What is claimed is:

1. A smell-proof portable container, comprising:
a portable case; and
a compartment within the case, the compartment containing a lining comprising:
an inner layer comprising a non-woven fabric,
a middle layer comprising active carbon filtering material, and
an outer layer comprising the non-woven fabric,
wherein the middle layer adsorbs odor particles and pollutant particles emitted by contents of the compartment.

2. The system of claim 1, wherein the active carbon filtering material comprises carbon filter fiber with activated carbon.

3. The system of claim 1, wherein the lining is directed to preventing smells and odors associated with the contents from being externally detectable.

4. The system of claim 1, wherein the contents comprise at least one of human products, animal products, food, spices, smokable materials, and chemical materials.

5. The system of claim 1, wherein the inner and outer layer are made of at least one of a breathable synthetic component and a breathable natural component.

6. The system of claim 5, wherein the non-woven fabric is held together by small fibers directed to supporting structural integrity of an inner-facing surface of fibers of the middle layer.

7. The system of claim 1, wherein the inner layer prevents at least one of dirt, dust, and debris from passing to the middle layer.

8. The system 1, wherein the case comprises multiple compartments containing the lining.

9. A method of containing odors emitted by contained materials, comprising:
a portable container receiving storage of an odiferous material, the material emitting at least one of gaseous and solid effluent;
the container, via a first layer, collecting at least one of dirt, dust, and debris emitted by the material;
the container, via a second layer, collecting odor particles and pollutant particles from the material; and
the container, via a third and outermost layer, further collecting effluent associated with the material.

10. The method of claim 9, further comprising the first, second, and third layers together comprising a lining of a compartment of the container.

11. The method of claim 10, further comprising the lining and a casing of the container promoting prevention of external detection of odors emitted by the material.

12. The method of claim 9, wherein the second layer comprises active carbon filtering material comprising carbon filter fiber with activated carbon.

13. The method of claim 9, wherein the first and third layer are made of at least one of a breathable synthetic component and a breathable natural component.

14. The method of claim 9, wherein the container has a plurality of compartments containing the lining.

15. A system for containing odors and particles emitted by materials, comprising:
a portable container; and
a compartment within the container, the compartment containing odiferous materials and lined with:
a first layer of non-woven fabric;
a carbon filter layer held in place by the first layer; and
a second layer of non-woven fabric.

16. The system of claim 15, wherein the first layer promotes prevention at least one of dirt, dust, and debris associated with the materials from passing to the carbon filter layer.

17. The system of claim 15, wherein the carbon filter layer adsorbs odor particles and pollutant particles emitted by the materials.

18. The system of claim 15, wherein the carbon filter layer is made from active carbon filtering material, the filtering material comprising carbon filter fiber with activated carbon.

19. The system of claim 15, wherein the first layer and the second layer of non-woven fabric are made of at least one of a breathable synthetic component and a breathable natural component.

20. The system of claim 15, wherein the first layer is held together by small fibers directed to maintaining structural integrity of an inner-facing surface of fibers of the carbon filter layer.
